(19) United States
(12) Patent Application Publication
(10) Pub. No.: US 2015/0081702 A1
(43) Pub. Date: Mar. 19, 2015

(54) INFORMATION PROCESSING SYSTEM, INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Natsuki Kato, Kawasaki-shi (JP)

(21) Appl. No.: 14/487,646

(22) Filed: Sep. 16, 2014

(30) Foreign Application Priority Data
Sep. 18, 2013 (JP) 2013-193037

(51) Int. Cl. G06F 17/30; H04L 29/08

(52) U.S. Cl. CPC G06F 17/3007; G06F 17/30091; H04L 67/1097
USPC 707/736; 707/803

(57) ABSTRACT

If a multifunctional peripheral (MFP) that generates files receives a selection of a folder from a plurality of hierarchically-managed folders, the MFP gives a generated file a file name including at least a name of the selected folder and a name of a folder located at a higher hierarchical level than the selected folder.

### BACKGROUND

1. Field

Aspects of the present invention generally relate to an information processing system, an information processing apparatus, and an information processing method for giving a file name to a file, and a storage medium.

2. Description of the Related Art

Conventionally, a scanner apparatus configured to read an image on a document to generate image data has been known. Image data generated by the scanner apparatus can be converted into a file. Thereafter, the file can be sent to an external device (personal computer (PC), file server, etc.) on a network, and stored in a folder created in the external device. If a folder is created in the scanner apparatus, the image data file can also be stored in the folder.

At the time of designating the folder as the storage location of the image data, information about folders hierarchically managed in the external device or the scanner apparatus is acquired to display a list of the folders on a display unit (Japanese Patent Application Laid-Open No. 2008-072256). The user of the scanner apparatus can designate as the storage location of the image data any folder from the list of folders on the display unit.

The file stored in the folder can be given a file name, but there has been a problem that if the name of the stored file has no relevance to the name of the folder storing the file, it is difficult to determine from the file name the folder that stores the file. Furthermore, there has been another problem that since the file stored in the folder can be moved to another folder according to a command from the user, if the user erroneously moves the file, the folder that originally stored the file can no longer be identified.

To deal with the problems, Japanese Patent Application Laid-Open No. 2010-055539 discusses a technique in which at the time of storing a file in a folder, the file is given a file name that includes the name of the folder. However, this technique discussed in Japanese Patent Application Laid-Open No. 2010-055539 is not effective on the following case.

Suppose that a folder named [User A] and a folder named [User B] are located in the same hierarchical level. Further, suppose that a folder named [Report] is located immediately under the folder [User A], and another folder named [Report] is also located immediately under the folder [User B].

When the technique of Japanese Patent Application Laid-Open No. 2010-055539 is employed for this situation, a file named [Report] is stored in the folder [Report] located immediately under the folder [User A], and another file named [Report] is also stored in the folder [Report] located immediately under the folder [User B]. In this case, both files are given the same file name. Thus, if the files are moved to another folder, a problem arises that the original folder cannot be identified.

### SUMMARY

Aspects of the present invention are generally directed to providing a system that can give an appropriate file name with ease to a file to be stored in a hierarchically-managed folder.

According to an aspect of the present invention, an information processing system includes a management unit configured to hierarchically manage a plurality of folders, a generation unit configured to generate a file, a reception unit configured to receive selection of any folder from the plurality of folders, a giving unit configured to give the file generated by the generation unit a file name including at least a name of the selected folder and a name of a folder located in a higher hierarchical level than the selected folder, and a storage unit configured to store in the selected folder the file to which the giving unit has given the file name.

Further features of the present disclosure will become apparent from the following description of exemplary embodiments with reference to the attached drawings.

### BRIEF DESCRIPTION OF THE DRAWINGS

FIG. 1 is an overall view illustrating an information processing system according to an exemplary embodiment.

FIG. 2 is a hardware configuration diagram illustrating a multifunction peripheral (MFP) according to an exemplary embodiment.

FIG. 3 is a hardware configuration diagram illustrating a file server according to an exemplary embodiment.

FIG. 4 is a flow chart illustrating operations of the MFP according to an exemplary embodiment.

FIGS. 5A and 5B each illustrate an operation screen of the MFP according to an exemplary embodiment.

FIGS. 6A and 6B each illustrate an operation screen of the MFP according to an exemplary embodiment.

FIGS. 7A and 7B each illustrate an operation screen of the MFP according to an exemplary embodiment.

FIG. 8 is a flow chart illustrating operations of the MFP according to an exemplary embodiment.

FIG. 9 illustrates an operation screen of the MFP according to an exemplary embodiment.

FIG. 10 is a flow chart illustrating operations of the MFP according to an exemplary embodiment.

FIG. 11 is a flow chart illustrating operations of the MFP according to an exemplary embodiment.

FIG. 12 is a flow chart illustrating operations of the MFP according to an exemplary embodiment.

### DESCRIPTION OF THE EMBODIMENTS

Various exemplary embodiments will be described in detail below with reference to the drawings. The exemplary embodiments described below are not intended to limit the claimed invention. Further, all the combinations of features described in the exemplary embodiments are not necessarily required for the solution of the invention.

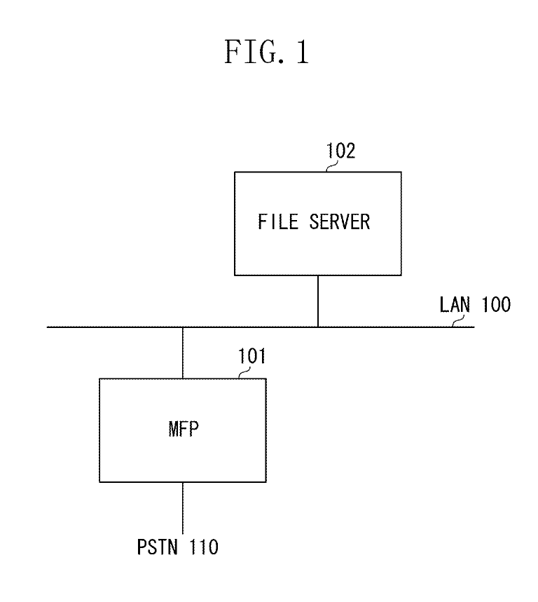

First, a first exemplary embodiment will be described below. FIG. 1 is an overall view illustrating an information processing system. An MFP 101 and a file server 102 are communicably connected to each other on a network (local area network (LAN)) 100. The MFP 101 is an example of an information processing apparatus. While the information processing apparatus will be described using an MFP as an example, the information processing apparatus is not limited to the MFP and may be any other apparatus (e.g., a PC and a mobile terminal) having a function of giving a file name to a file.

The file server 102 is an example of an external device. While the MFP 101 and the file server 102 are collectively referred to as an information processing system in the present exemplary embodiment, the MFP 101 alone may also be referred to as an information processing system. The MFP 101 is connected to a public switched telephone network (PSTN) 110 and can communicate with a facsimile apparatus (not illustrated) to send or receive image data.

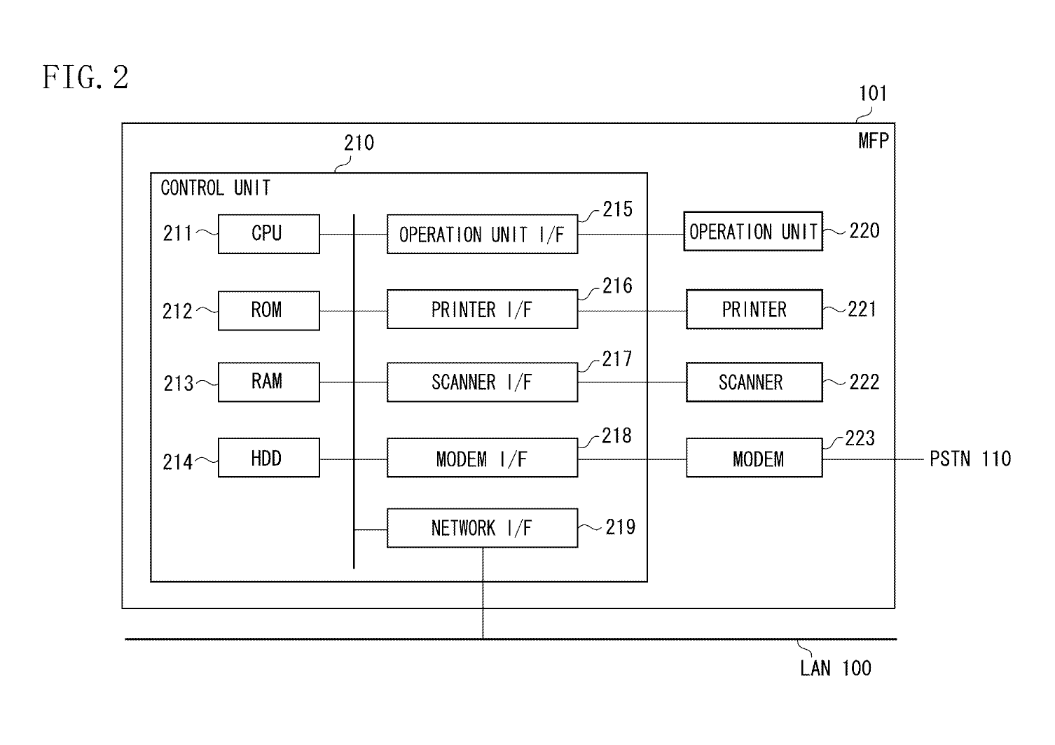

FIG. 2 is a hardware configuration diagram illustrating the MFP 101. A control unit 210 including a central processing unit (CPU) 211 controls operations of the entire MFP 101. The CPU 211 reads a control program stored in a read-only memory (ROM) 212 to control reading, printing, communication, and the like. A random access memory (RAM) 213 is used as a main memory of the CPU 211 and a temporary storage space such as a work space. While the MFP 101 is configured such that the one CPU 211 executes each process in flow charts described below by use of one memory (RAM 213 or hard disk drive (HDD) 214), any other configuration may also be employed. For example, a plurality of CPUs and a plurality of RAMs or HDDs may cooperate to execute each process illustrated in the flow charts.

The HDD 214 stores image data and various types of programs. An operation unit interface (I/F) 215 connects an operation unit 220 to the control unit 210. The operation unit 220 includes a liquid crystal display unit having a touch panel function, a keyboard, and the like. The operation unit 220 plays a role as a reception unit configured to receive a user operation, a user input, and a user command.

A printer I/F 216 connects a printer 221 to the control unit 210. Image data to be printed by the printer 221 is transferred from the control unit 210 via the printer I/F 216 and then printed on a recording medium by the printer 221.

A scanner I/F 217 connects a scanner 222 to the control unit 210. The scanner 222 reads an image on a document to generate image data and inputs the image data to the control unit 210 via the scanner I/F 217. The MFP 101 can convert the image data generated by the scanner 222 into a file, and then send the file to the file server 102 using the Web-based Distributed Authoring and Versioning (WebDAV) protocol. The conversion into a file refers to generation of a file containing the image data, and any file format may be used such as the Portable Document Format (PDF) and the Tagged Image File Format (TIFF). Hereinafter, image data converted into a file will be referred to as an image file. In place of the WebDAV, the File Transfer Protocol (FTP) or the Server Message Block (SMB) may also be used.

A modem I/F 218 connects a modem 223 to the control unit 210. The modem 223 executes communication of image data with a facsimile apparatus (not illustrated). A network I/F 219 connects the control unit 210 (MFP 101) to the LAN 100. The MFP 101 uses the network I/F 219 to send an image file and information to and receive various types of information from an external device (the file server 102, etc.) on the LAN 100.

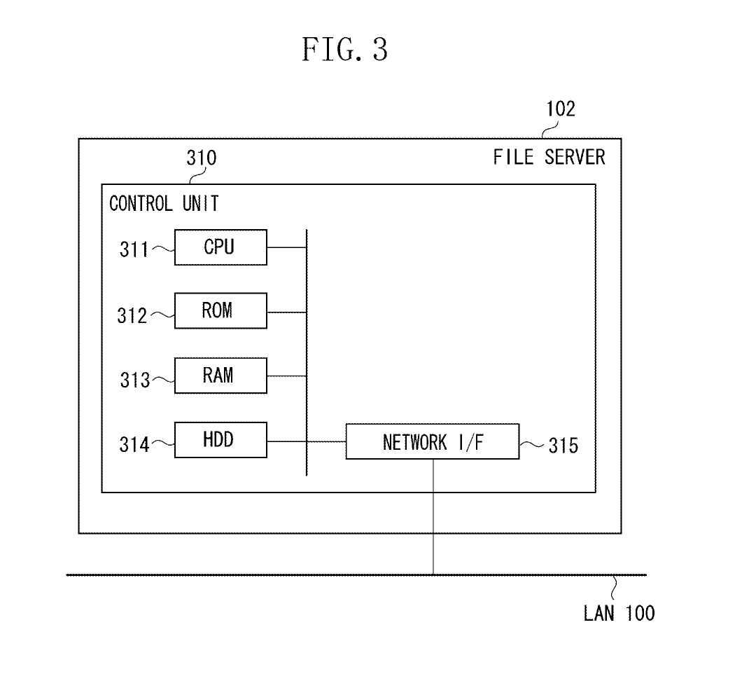

FIG. 3 is a hardware configuration diagram illustrating the file server 102. A control unit 310 including a CPU 311 controls operations of the entire file server 102. The CPU 311 reads a control program stored in a ROM 312 to execute various control processes. A RAM 313 is used as a main memory of the CPU 311 and a temporary storage space such as a work space. A HDD 314 stores image data and various programs. In the HDD 314, multiple hierarchically-managed folders are created so that images files sent from the MFP 101 can be stored in the folders. The user can view and operate the image files stored in the folders using a PC (not illustrated) on the LAN 100.

A network I/F 315 connects the control unit 310 (the file server 102) to the LAN 100. The file server 102 uses the network I/F 315 to send or receive various types of information to or from other devices on the LAN 100.

The following describes operations of the information processing system (service provided using the information processing system) using a cram school support system as an example. The cram school support system is a system for streamlining works at a cram school that uses a large amount of documents printed on sheets. The cram school support system facilitates especially the works of reading the above-described document by use of the scanner and uploading the scanned document to the file server. The cram school support system is realized using an application named “cram school filing” installed in the MFP 101 and a file system of the file server 102 that hierarchically manages a plurality of folders.

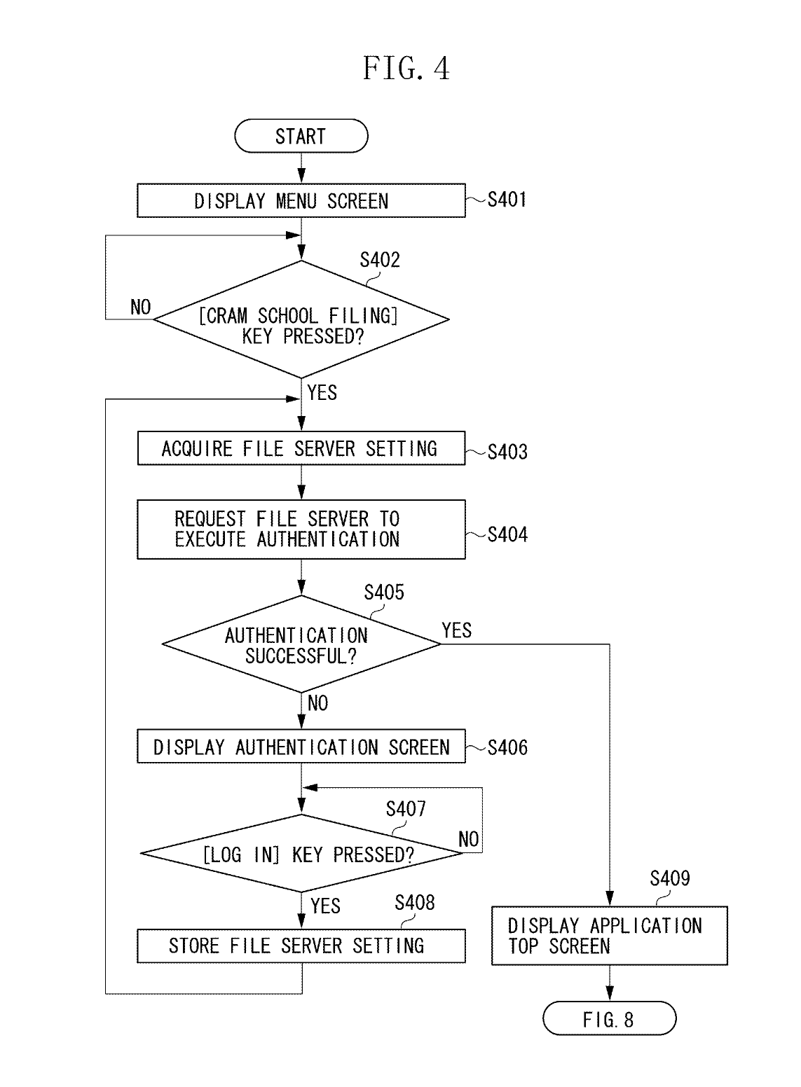

FIG. 4 is a flow chart illustrating operations from when the MFP 101 activates to when an application top screen 610 of the application “cram school filing” is displayed. The CPU 211 of the MFP 101 executes a control program stored in the HDD 214 to realize each operation (step) illustrated in the flow chart in FIG. 4.

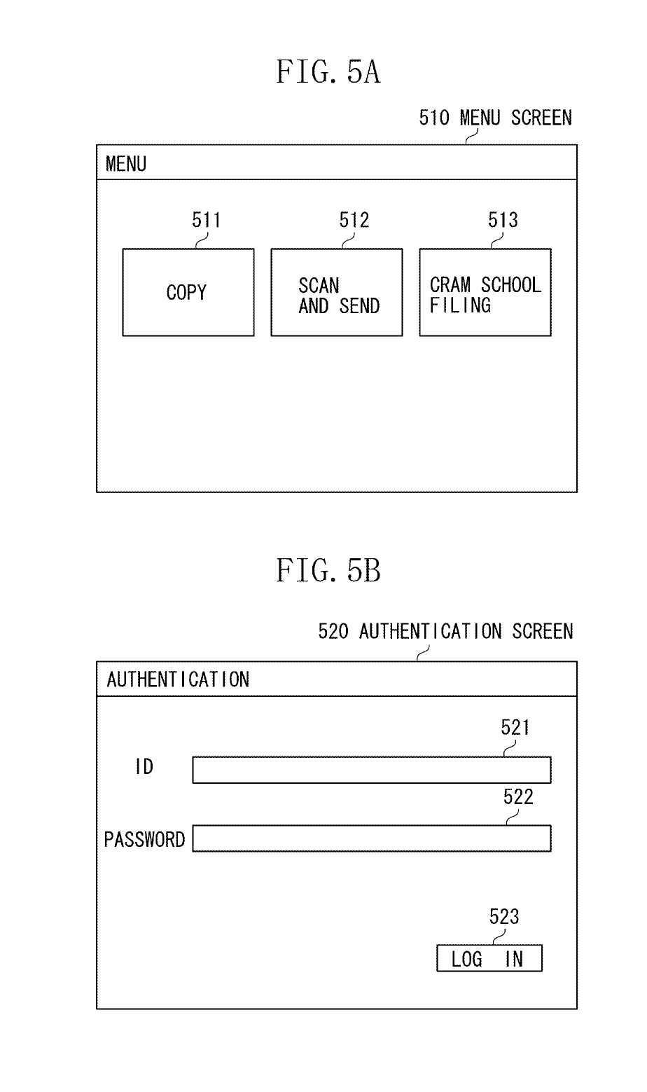

In step S401, the CPU 211 displays a menu screen 510 illustrated in FIG. 5A on the operation unit 220. The menu screen 510 displays a list of functions and applications included in the MFP 101. A [Copy] key 511 and a [Scan and send] key 512 illustrated in FIG. 5A correspond to standard functions (native functions) included in the MFP 101. On the other hand, a [Cram school filing] key 513 corresponds to an additionally-installed Java (registered trademark) based application. The MFP 101 may also include any other native functions and applications (not illustrated).

In step S402, the CPU 211 determines whether the user has pressed the [Cram school filing] key 513. If the user has pressed the [Cram school filing] key 513 (YES in step S402), the CPU 211 proceeds to step S403. If the user has not pressed the [Cram school filing] key 513 (NO in step S402), the CPU 211 stands by until the user presses the [Cram school filing] key 513. If the [Copy] key 511 or the [Scan and send] key 512 is pressed, the CPU 211 executes a function corresponding to the pressed key.

In step S403, the CPU 211 acquires a file server setting stored in the HDD 214. The file server setting is a Comma-Separated Values (CSV) format file or an Extensible Markup Language (XML) format file containing information about the file server 102. The file server setting contains a host name of the file server 102 and information about a root folder from which a folder path starts. The file server setting also contains authentication information (ID, password) for logging in to the file server 102. The administrator or user of the MFP 101 needs to input in advance each piece of information contained in the file server setting via a file server setting screen displayed on a PC (not illustrated).

In step S404, the CPU 211 requests the file server 102 to execute authentication based on the file server setting acquired in step S403. If the authentication is successful, the MFP 101 can access the file server 102. In step S405, the CPU 211 determines whether the authentication of the file server 102 is successful and the MFP 101 has logged in to the file server 102. If the authentication is successful (YES in step S405), the CPU 211 proceeds to step S409. If the authentication fails (NO in step S405), the CPU 211 proceeds to step S406.

In step S406, the CPU 211 displays on the operation unit 220 an authentication screen 520 illustrated in FIG. 5B. When the authentication of the file server 102 fails, there may be an error in the authentication information contained in the file server setting. Thus, the CPU 211 prompts the user to input authentication information via the authentication screen 520. In step S407, the CPU 211 determines whether the user has pressed a [Log in] key 523. If the user has pressed the [Log in] key 523 (YES in step S407), the CPU 211 proceeds to step S408. If the user has not pressed the [Log in] key 523 (NO in step S407), the CPU 211 stands by until the [Log in] key 523 is pressed.

In step S408, the CPU 211 stores in the HDD 214 the authentication information input by the user and then returns to step S403. The CPU 211 executes step S408 so that the user will not be required to input authentication information at the time of subsequent logging in, but the CPU 211 may skip steps S408 and S403 to proceed to step S404. Alternatively, the CPU 211 may skip steps S408 and S403 to proceed to step S404, and in step S405, if the CPU 211 determines that the authentication is successful, then the CPU 211 may store the authentication information.

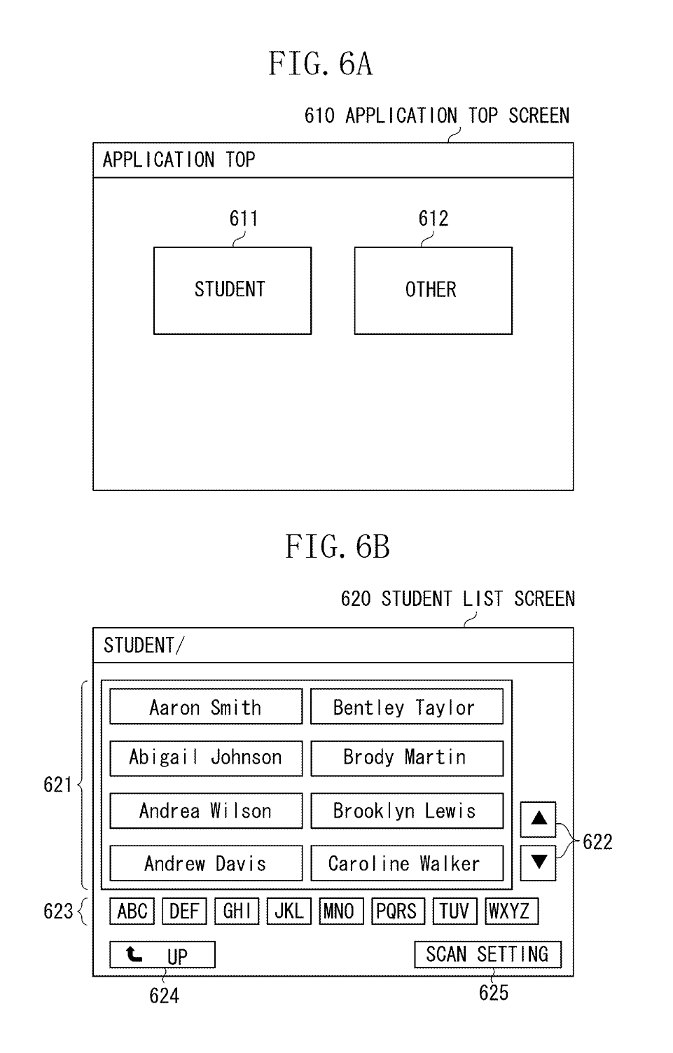

In step S409, the CPU 211 displays on the operation unit 220 the application top screen 610 illustrated in FIG. 6A. The application top screen 610 displays a [Student] key 611 and an [Other] key 612. In the cram school support system, a folder named [Student] and a folder named [Other] are created immediately under the root folder. The MFP 101 acquires from the file server 102 information about the folders located immediately under the root folder, and the MFP 101 displays the [Student] key 611 and the [Other] key 612 based on the information.

To upload to the file server 102 a document regarding a student enrolled in the cram school, the user presses the [Student] key 611. To upload any other documents to the file server 102, the user presses the [Other] key 612.

If the user presses the [Student] key 611, the operation unit 220 displays a student list screen 620 illustrated in FIG. 6B. An area 621 displays a list of student names registered in the cram school support system. Immediately under the [Student] folder, subfolders with a student name set as its folder name are created for every student corresponding to the number of students. The MFP 101 acquires from the file server 102 information about the folders located immediately under the [Student] folder, and the MFP 101 displays the area 621 based on the information. The user can create a new folder of a student or delete a folder of a student by the PC (not illustrated). Further, the folders of the students are rearranged in alphabetical order and displayed by the MFP 101.

A scroll key 622 is used for displaying (scrolling the screen) in the area 621 a name of a student that is not displayed in the area 621. An index key 623 is used for designating the first letter of a student name so that the area 621 displays student names that begin with the designated letter. An [Up] key 624 is used for displaying a folder located at one level higher. If the user presses the [Up] key 624, the application top screen 610 is displayed. A [Scan setting] key 625 is used for displaying a scan setting screen described below. If the [Scan setting] key 625 is used to display the scan setting screen, an image file created using the scanner 222 is stored in the [Student] folder. The [Scan setting] key 625 may be hidden when storage of image data in the [Student] folder is not allowed.

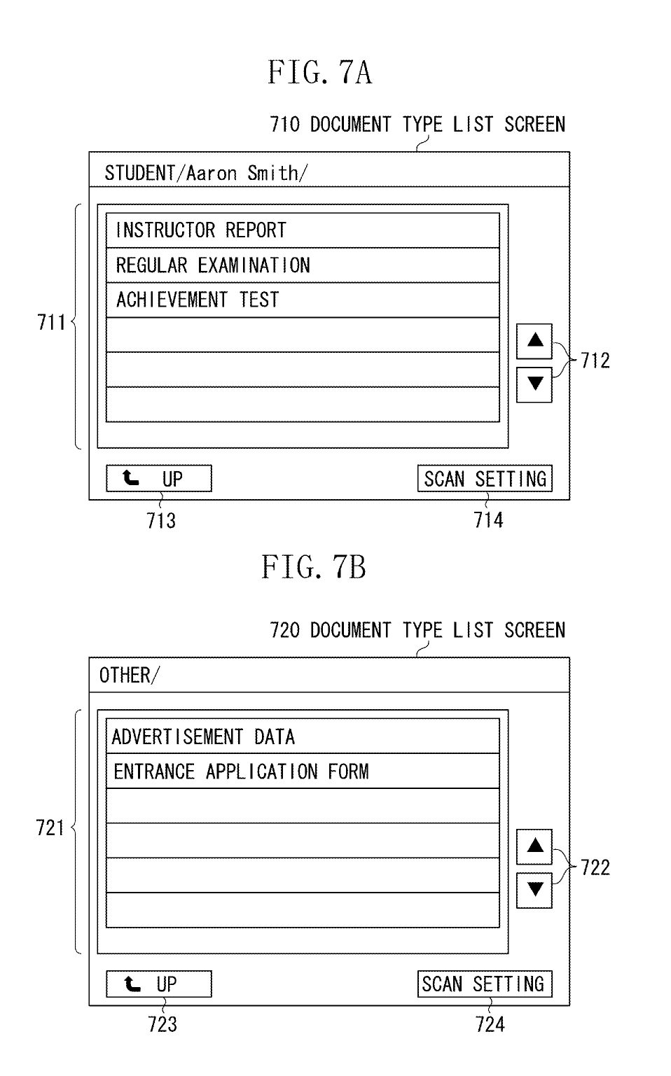

If the user presses any of the operation keys included in the area 621, a document type list screen 710 illustrated in FIG. 7A is displayed. FIG. 7A illustrates the case in which a student named [Aaron Smith] (folder named [Aaron Smith]) is selected. An area 711 displays a list of document types registered in the cram school support system. Immediately under the [Aaron Smith] folder, subfolders to which document type names respectively are set as their folder names are created. These folders are also created immediately under folders of other students.

When displaying the document type list screen 710, the MFP 101 acquires from the file server 102 information about the folders located immediately under the [Aaron Smith] folder, and the MFP 101 displays the area 711 based on the information. The user can create a new folder of any of the document types or delete a folder by a PC (not illustrated).

A scroll key 712 is used for displaying (scrolling the screen) in the area 711 document types that are not displayed in the area 711. Since there are only three folders located immediately under the [Aaron Smith] folder, all of the three folders are displayed on the screen illustrated in FIG. 7A. However, when there are seven or more folders, the screen cannot display all of the folders. In this case, the scroll key 712 is used. Unlike the student list screen 620, the document type list screen 710 displays no index key. An [Up] key 713 is used for displaying a folder located in one level higher. If the user presses the [Up] key 713, the student list screen 620 is displayed. A [Scan setting] key 714 is used for displaying a scan setting screen described below. If the [Scan setting] key 714 is used to display the scan setting screen, an image file generated by the scanner 222 is stored in the [Aaron Smith] folder.

If the user presses the [Other] key 612 on the application top screen illustrated in FIG. 6A, a document type list screen 720 illustrated in FIG. 7B is displayed. An area 721 displays a list of document types registered in the cram school support system. Immediately under the [Other] folder, subfolders to which document type names respectively are given as their folder names, are created. When displaying the document type list screen 710, the MFP 101 acquires from the file server 102 information about the folders located immediately under the [Other] folder, and the MFP 101 displays the area 721 based on the information. The user can create a new document type folder or delete a folder by a PC (not illustrated).

A scroll key 722 is used for displaying (scrolling the screen) in the area 721 the document types that are not displayed in the area 721. Since there are only two folders immediately under the [Other] folder, all of the folders are displayed on the screen illustrated in FIG. 7B. However, when there are seven or more folders, the screen cannot display all of the folders. In this case, the scroll key 722 is used. Unlike the student list screen 620, the document type list screen 720 displays no index key. An [Up] key 723 is used for displaying a folder located at one level higher. If the user presses the [Up] key 723, the application top screen 610 is displayed. A [Scan setting] key 724 is used for displaying the scan setting screen described below. If the [Scan setting] key 724 is used to display the scan setting screen, an image file created by the scanner 222 is stored in the [Other] folder.

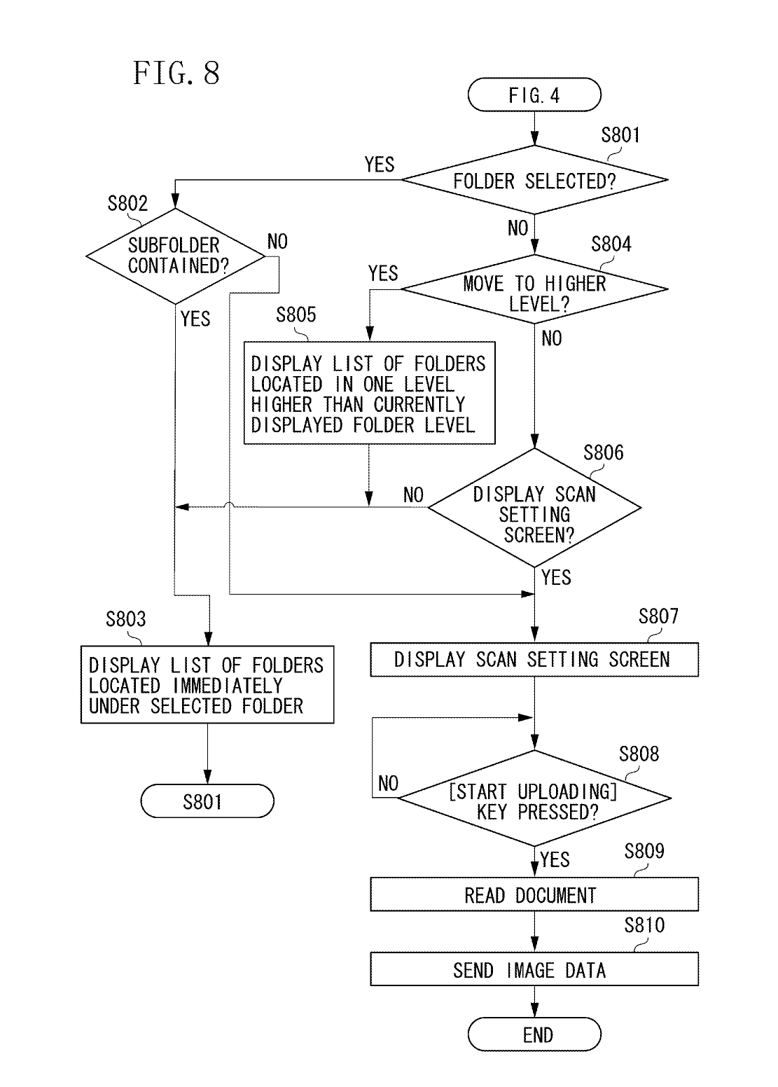

FIG. 8 is a flow chart illustrating operations of the MFP 101 including a screen transition after the application top screen 610 is displayed. The CPU 211 of the MFP 101 executes a control program stored in the HDD 214 to realize each operation (step) illustrated in the flow chart in FIG. 8.

In step S801, the CPU 211 determines whether the user has selected a folder. If the user has pressed any of the [Student] key 611, the [Other] key 612, and the operation keys included in the areas 621, 711, and 721 (YES in step S801), the CPU 211 determines that the user has selected a folder, and the CPU 211 proceeds to step S802.

In step S802, the CPU 211 determines whether the folder selected in step S801 is a folder containing a subfolder. The CPU 211 executes this determination by inquiring of the filer server 102 whether a subfolder exists. In the present exemplary embodiment, if the user has pressed any of the [Student] key 611, the [Other] key 612, and the operation keys included in the area 621 (YES in step S802), the CPU 211 determines that the selected folder contains a subfolder, and the CPU 211 proceeds to step S803. On the other hand, if the user has pressed any of the operation keys included in the areas 711 and 721 (NO in step S802), the CPU 211 determines that the selected folder does not contain a subfolder, and the CPU 211 proceeds to step S807. Even if a file is located immediately under the selected folder, unless a folder exists there, the CPU 211 determines that the selected folder does not contain a subfolder.

In step S803, the CPU 211 displays a list of folders located immediately under the folder selected in step S801 (folders located at one level lower than the folder selected in step S801). Specifically, this corresponds to the screen transition from FIG. 6A to FIG. 6B or 7B, or the screen transition from FIG. 6B to FIG. 7A.

In step S804, the CPU 211 determines whether the user has commanded a screen transition to the higher level. In the present exemplary embodiment, if the user has pressed any of the [Up] keys 624, 713, and 723 (YES in step S804), the CPU 211 determines that the user has commanded the screen transition to the higher level, and the CPU 211 proceeds to step S805. In step S805, the CPU 211 displays a list of folders located at one level higher than the currently displayed folder level. Specifically, this corresponds to the screen transition from FIG. 6B or 7B to FIG. 6A or the screen transition from FIG. 7A to FIG. 6B.

In step S806, the CPU 211 determines whether the user has given a command to display the scan setting screen. In the present exemplary embodiment, if the user has pressed any of the [Scan setting] keys 625, 714, and 724 (YES in step S806), the CPU 211 determines that the user has given a command to display the scan setting screen, and the CPU 211 proceeds to step S807.

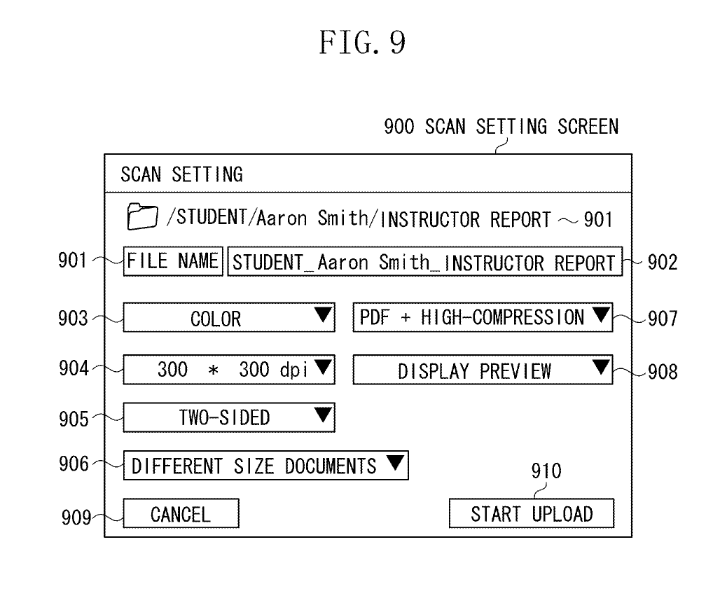

In step S807, the CPU 211 displays a scan setting screen 900 illustrated in FIG. 9. FIG. 9 illustrates the case in which the folder named [Instructor report] located immediately under the student named [Aaron Smith] (folder named [Aaron Smith]) is selected. An area 901 displays folder path information that indicates a storage location of an image file generated by the scanner 222. The folder path information indicates a relative path (portion located at a lower hierarchical level than the root folder) with respect to the root folder. The example illustrated in FIG. 9 indicates that an image file is stored in the [Instructor report] folder.

A [File name] key 901 is used for setting a file name of an image file. If the user presses the [File name] key 901, a software keyboard is displayed to enable the user to input a string of characters to be used as a file name. Further, an area 902 displays a default file name. Details of a method for creating the file name to be displayed will be described below.

Operation keys 903 to 908 are used for setting document reading parameters. A reading parameter other than those illustrated in FIG. 9 may be added, or some of the reading parameters illustrated in FIG. 9 may be omitted.

The operation key 903 is used for setting a color mode. The user can select a desired color mode from a list of choices [Color], [Grayscale], and [Black-and-White] that appear in a pull-down menu. The operation key 904 is used for setting a resolution. The user can select a desired resolution from a list of choices [300*300 dpi], [200*200 dpi], and the like that appears in a pull-down menu.

The operation key 905 is used for setting a one-sided reading mode or a two-sided reading mode. The user can select a desired two-sided mode from a list of choices [Two-sided] and [One-sided] that appears in a pull-down menu. The operation key 906 is used for setting a different size documents mode. The user can select a desired different size documents mode from a list of choices [Different size documents] and [Same size documents] that appear in a pull-down menu.

The operation key 907 is used for setting a file format. The user can select a desired file format from a list of choices “TIFF,” “PDF,” “PDF+High-compression,” and the like. The operation key 908 is used for setting a preview display mode. The user can select a desired preview display mode from a list of choices [Display preview] and [No preview] that appear in a pull-down menu.

If the user presses a [Cancel] key 909, the scan setting is stopped, and the user can change a storage location to another folder. If the user presses a [Start uploading] key 910, the CPU 211 reads a document and sends an image file to the file server 102.

Referring back to FIG. 8, in step S808, the CPU 211 determines whether the user has pressed the [Start uploading] key 910. If the user has pressed the [Start uploading] key 910 (YES in step S808), the CPU 211 proceeds to step S809. If the user has not pressed the [Start uploading] key 910 (NO in step S808), the CPU 211 stands by until the [Start uploading] key 910 is pressed.

In step S809, the CPU 211 reads a document and generates image data using the scanner 222 based on the settings selected via the scan setting screen, and the CPU 211 gives a file name to the generated image file. In step S810, the CPU 211 sends the image data to the file server 102.

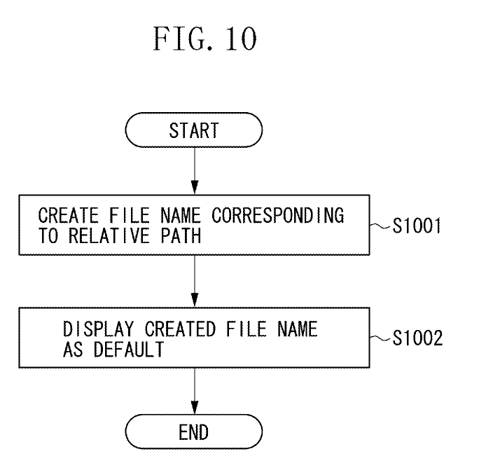

FIG. 10 is a flow chart illustrating operations at the time when the MFP 101 displays a default file name on the scan setting screen in FIG. 9 (details of step S807). The CPU 211 of the MFP 101 executes a control program stored in the HDD 214 to realize each operation (step) illustrated in the flow chart in FIG. 10.

In step S1001, the CPU 211 creates a file name corresponding to a file path (relative path portion) specified in the area 901. In the example illustrated in FIG. 9, the [Aaron Smith] folder is located immediately under the [Student] folder, and an image file is stored in the [Instructor report] folder located immediately under the [Aaron Smith] folder, so the file name is [Student_Aaron Smith_Instructor report]. Here, while [(under bar)] is used as a delimiter mark in the folder name, any other marks may also be used. The folder name may also include the extension of a file. The folder name may further include the root folder. In step S1002, the CPU 211 displays, in the area 902, the default file name created in step S1001.

The following describes a second exemplary embodiment. Features of the second exemplary embodiment are similar to those of the first exemplary embodiment, except that the method for creating a default file name to be displayed in the second exemplary embodiment is different from that used in the first exemplary embodiment.

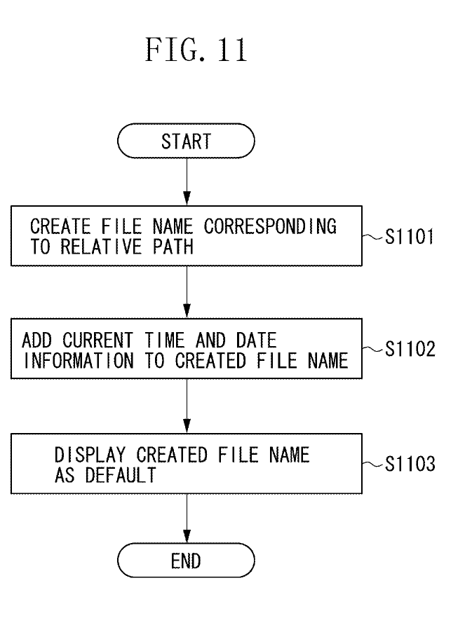

FIG. 11 is a flow chart illustrating operations at the time when the MFP 101 displays a default file name on the scan setting screen in FIG. 9 (details of step S807). The flow chart illustrated in FIG. 11 is a replacement for the flow chart illustrated in FIG. 10. The CPU 211 of the MFP 101 executes a control program stored in the HDD 214 to realize each operation (step) illustrated in the flow chart in FIG. 11.

In step S1101, the CPU 211 creates a file name corresponding to a file path (relative path portion) specified in the area 901. In the example illustrated in FIG. 9, the [Aaron Smith] folder is located immediately under the [Student] folder, and an image file is stored in the [Instructor report] folder located immediately under the [Aaron Smith] folder. Thus, the file name is [Student_Aaron Smith_instructor report]. Here, while [_(under bar)] is used as a delimiter mark in the folder name, any other marks may also be used. The folder name may also include the extension of a file. The folder name may further include the root folder.

In step S1102, the CPU 211 adds current time and date information (year, month, date, hour, minute, and second) to the last part of the file name. Specifically, if the current time and date is Jan. 1, 2013, 12:00:00, the file name is [Student_Aaron Smith_instructor report_{—}20130101120000]. The current time and date may be the time at which the scan setting screen 900 is displayed or the time at which step S1102 is executed. In step S1103, the CPU 211 displays the default file name created in steps S1101 and S1102 in the area 902. Alternatively, while the file name created in step S1101 is displayed in the area 902, the time and date information may be hidden. In the case in which the time and date information is hidden, the time at which a document in step S809 is read may be used as the current time and date.

The following describes a third exemplary embodiment. Features of the third exemplary embodiment are similar to those of the first exemplary embodiment, except that the method for creating a default file name to be displayed in the third exemplary embodiment is different from that used in the first exemplary embodiment.

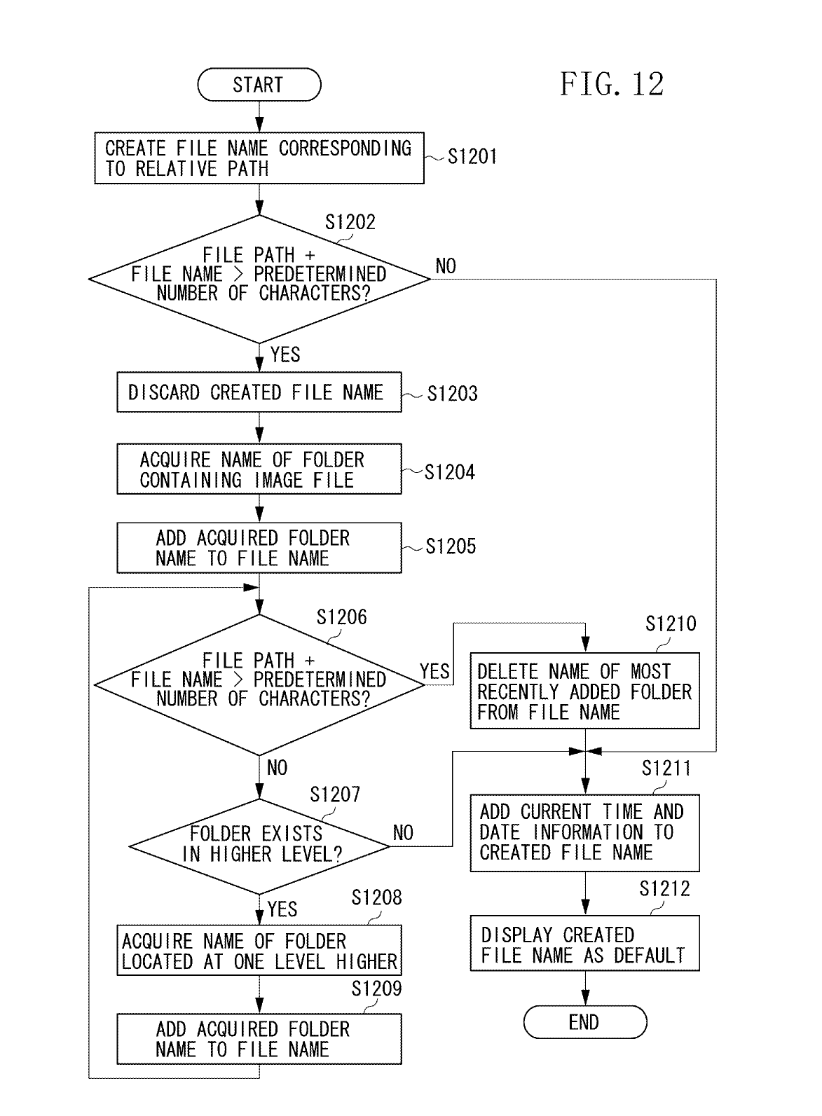

FIG. 12 is a flow chart illustrating operations at the time when the MFP 101 displays a default file name on the scan setting screen in FIG. 9 (details of step S807). The flow chart illustrated in FIG. 12 is a replacement for the flow chart illustrated in FIG. 10. The CPU 211 of the MFP 101 executes a control program stored in the HDD 214 to realize each operation (step) illustrated in the flow chart in FIG. 12.

In step S1201, the CPU 211 creates a file name corresponding to a file path (relative path portion) specified in the area 901. In the example illustrated in FIG. 9, the [Aaron Smith] folder is located immediately under the [Student] folder, and an image file is stored in the [Instructor report] folder located immediately under the [Aaron Smith] folder. Thus, the file name is [Student_Aaron Smith_instructor report]. Here, while [(under bar)] is used as a delimiter mark in the folder name, any other marks may also be used. The folder name may also include the extension of a file. The folder name may further include the root folder.

In step S1202, the CPU 211 determines whether the sum of the file name created in step S1201 and the file path of the area 901 exceeds a predetermined number of characters. If the sum exceeds the predetermined number of characters (YES in step S1202), the CPU 211 proceeds to step S1203. If the sum does not exceed the predetermined number of characters (NO in step S1202), the CPU 211 proceeds to step S1211. The reason why this determination is made is because the file server 102 has a limitation of the total number of characters of the folder path and the file name to avoid in advance an error caused by an excess number of characters.

In step S1203, the CPU 211 discards the file name created in step S1201. In step S1204, the CPU 211 acquires a name of a folder that is a storage location of an image file (in the example illustrated in FIG. 9, the name of the folder is [Instructor report]). In step S1205, the CPU 211 adds to the file name the folder name acquired in step S1204.

In step S1206, the CPU 211 determines whether the sum of the file name acquired in step S1205 and the file path of the area 901 exceeds the predetermined number of characters. If the sum exceeds the predetermined number of characters (YES in step S1206), the CPU 211 proceeds to step S1210. If the sum does not exceed the predetermined number of characters (NO in step S1206), the CPU 211 proceeds to step S1207.

In step S1207, the CPU 211 determines whether a folder exists at a higher hierarchical level. For example, as to the [Instructor report] folder, the [Aaron Smith] folder exists at the higher hierarchical level. As to the [Student] folder, on the other hand, no folder exists at the higher hierarchical level (the existence of the root folder is ignored herein). If a folder exists at the higher hierarchical level (YES in step S1207), the CPU 211 proceeds to step S1208. If no folder exists at the higher hierarchical level (NO in step S1207), the CPU 211 proceeds to step S1211. In step S1208, the CPU 211 acquires the name of the folder located at one level higher. In step S1209, the CPU 211 adds to the file name the folder name acquired in step S1208, and then the CPU 211 returns to step S1206.

In step S1206, if the CPU 211 determines that the sum of the file name acquired in step S1205 and the file path of the area 901 exceeds the predetermined number of characters (YES in step S1206), the CPU 211 proceeds to the step S1210 and deletes the most-recently-added folder name from the file name.

In step S1211, the CPU 211 adds the current time and date information (year, month, date, hour, minute, and second) to the file name. Specifically, if the current time and date is Jan. 1, 2013, 12:00:00, the current time and data information [_{—}20130101120000] is added to the last part of the file name. When the name of a folder that is a storage location of an image file is long, even if the name of the folder located at the higher hierarchical level is not yet added, the number of characters already exceeds the predetermined number. In this case, a file name that only includes the time and date information ([20130101120000]) is created.

In step S1212, the CPU 211 displays the default file name created in steps S1201 to S1211 in the area 902. While the file name created in steps S1201 to S1210 is displayed in the area 902, the time and date information may be hidden.

As the foregoing describes, each of the cram school support systems according to the first to third exemplary embodiments includes the file server 102 configured to hierarchically manage a plurality of folders and the MFP 101 configured to create a file. If any of the plurality of folders managed by the file server is selected at the MFP 101, a file is given a file name that includes at least the name of the selected folder and the name of the folder located at the higher hierarchical level. Then, the file given the file name is stored in the selected folder.

The foregoing configuration can give with ease an appropriate file name to a file stored in a hierarchically managed folder.

The foregoing configuration is applicable to not only the cram school support systems but also any other systems that include an operation to store a file in a folder. The file to be stored may be anything other than an image, such as audio and text.

While the foregoing describes the examples in which the folders are managed in the outside (file server 102) of the scanner apparatus (MFP 101), in another example, folders are managed within the scanner apparatus (MFP 101). In this case, an image file created by reading a document is stored in a folder located within the scanner apparatus. Further, if the file server 102 is configured to give a file name, the above-described method for giving a file name may be executed at the file server 102.

### Other Exemplary Embodiment

Aspects of the present invention can also be realized by the following processing. Specifically, a storage medium storing program code of software configured to realize the functions of the exemplary embodiments described above is supplied to a system or an apparatus, and a computer (or CPU, MPU, or the like) of the system or the apparatus reads the program code stored in the storage medium.

In this case, the program code read from the storage medium realizes the functions of the exemplary embodiments described above, and the program code and the storage medium storing the program code constitute an aspect of the present invention.

### OTHER EMBODIMENTS

Additional embodiments can also be realized by a computer of a system or apparatus that reads out and executes computer executable instructions recorded on a storage medium (e.g., non-transitory computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not see to be limiting. The scope of the following claims is to be accorded the broadest interpretation so as to encompass all such modifications and equivalent structures and functions.

This application claims the benefit of Japanese Patent Application No. 2013-193037 filed Sep. 18, 2013, which is hereby incorporated by reference herein in its entirety.

What is claimed is:

1. An information processing system comprising:
a management unit configured to hierarchically manage a plurality of folders;
a generation unit configured to generate a file;
a reception unit configured to receive selection of any folder from the plurality of folders;
a giving unit configured to give the file generated by the generation unit a file name including at least a name of the selected folder and a name of a folder located at a higher hierarchical level than the selected folder; and
a storage unit configured to store in the selected folder the file to which the giving unit has given the file name.

2. The information processing system according to claim 1, further comprising a reading unit configured to read an image on a document to generate image data,
wherein the file generated by the generation unit contains the image data.

3. The information processing system according to claim 1, wherein the reception unit receives a user operation to a list of folders displayed on a display unit.

4. The information processing system according to claim 1, wherein the giving unit further includes determining, based on a number of characters of the name of the folder located at the higher hierarchical level, whether to include in the file name the name of the folder located at the higher hierarchical level.

5. The information processing system according to claim 1, wherein the management unit is included in a file server, and
wherein the generation unit, the reception unit, and the giving unit are included in an information processing apparatus configured to communicate with the file server.

6. An information processing apparatus comprising:
a generation unit configured to generate a file;
a reception unit configured to receive selection of any folder from a plurality of hierarchically-managed folders; and
a giving unit configured to give the file generated by the generation unit a file name including at least a name of the selected folder and a name of a folder located at a higher hierarchical level than the selected folder.

7. The information processing apparatus according to claim 6, further comprising a management unit configured to manage the plurality of hierarchically-managed folders.

8. The information processing apparatus according to claim 6, further comprising a communication unit configured to communicate with a file server configured to manage the plurality of hierarchically-managed folders.

9. The information processing apparatus according to claim 6, further comprising a reading unit configured to read an image on a document to generate image data,
wherein the file generated by the generation unit contains the image data.

10. The information processing apparatus according to claim 6, wherein the file to which the giving unit has given the file name is stored in the selected folder.

11. The information processing apparatus according to claim 6, wherein the reception unit receives a user operation to a list of folders displayed on a display unit.

12. The information processing apparatus according to claim 6, wherein the giving unit further includes determining, based on a number of characters of the name of the folder located at the higher hierarchical level, whether to include in the file name the name of the folder located at the higher hierarchical level.

13. An information processing method comprising:
hierarchically managing a plurality of folders;
generating a file;
receiving selection of any folder from the plurality of folders;
giving the generated file a file name including at least a name of the selected folder and a name of a folder located at a higher hierarchical level than the selected folder; and
storing in the selected folder the file to which the file name is given.

14. A non-transitory computer readable storage medium storing computer executable instructions for causing a computer to execute the method according to claim 13.

15. An information processing method comprising:
generating a file;
receiving selection of any folder from a plurality of hierarchically-managed folders; and
giving the generated file a file name including at least a name of the selected folder and a name of a folder located at a higher hierarchical level than the selected folder.

16. A non-transitory computer readable storage medium storing computer executable instructions for causing a computer to execute the method according to claim 15.
